(19) United States
(12) Patent Application Publication
(10) Pub. No.: US 2022/0309326 A1
(43) Pub. Date: Sep. 29, 2022

(54) LEARNING METHOD OF NEURAL NETWORK AND NEURAL PROCESSOR

(71) Applicant: ELECTRONICS AND TELECOMMUNICATIONS RESEARCH INSTITUTE, Daejeon (KR)

(72) Inventors: Tae Wook KANG, Daejeon (KR); Sung Eun KIM, Daejeon (KR); Kwang IL OH, Daejeon (KR); Jae-Jin LEE, Daejeon (KR); Hyuk KIM, Daejeon (KR); Hyung-IL PARK, Daejeon (KR); Kyung Jin BYUN, Daejeon (KR)

(21) Appl. No.: 17/550,530

(22) Filed: Dec. 14, 2021

(30) Foreign Application Priority Data
Mar. 24, 2021 (KR) 10-2021-0038073

(51) Int. Cl. G06N 3/04; G06N 3/08; G06N 3/063

(52) U.S. Cl. CPC G06N 3/049; G06N 3/08; G06N 3/063

(57) ABSTRACT

Disclosed is a learning method of a neural network which includes a first intermediate neuron layer and a second intermediate neuron layer. The method includes performing first learning, which is based on a first synaptic weight layer, with respect to input subjects and the first intermediate neuron layer, determining intermediate neurons, which will perform second learning, from among intermediate neurons of the first intermediate neuron layer, based on the number of spikes of each of spike output signals of the intermediate neurons of the first intermediate neuron layer, and performing the second learning, which is based on a second synaptic weight layer, with respect to the intermediate neurons determined to perform the second learning.

### CROSS-REFERENCE TO RELATED APPLICATIONS

This application claims priority under 35 U.S.C. § 119 to Korean Patent Application No. 10-2021-0038073 filed on Mar. 24, 2021, in the Korean Intellectual Property Office, the disclosures of which are incorporated by reference herein in their entireties.

### BACKGROUND

Embodiments of the present disclosure described herein relate to a learning method of a neural network and a neural processor, and more particularly, relate to a learning method of a spiking neural network including a plurality of intermediate neuron layers and a neural processor.

An artificial neural network (ANN) may be used to process information by applying human thinking, reasoning, and learning processes to an electronic device. The artificial neural network may process information by mimicking neurons and synapses contained in the human brain. The artificial neural network may provide the effective problem-solving ability for information by changing a connection strength of a synapse, that is, a weight of the synapse through learning. The artificial neural network may be applied to various fields such as risk recognition, security and monitoring, autonomous driving, smart management, and the Internet of Things.

A spiking neural network (SNN) may provide an artificial neural network running with a low power. Unlike a perceptron-based neural network or a convolution-based neural network, instead of a signal of a specific level, a pulse type of spike signal that toggles for a short time may be transferred between neurons in the spiking neural network. Because the spiking neural network transfers information through a spike signal toggling for a short time, the spiking neural network may operate with a low power.

### SUMMARY

Embodiments of the present disclosure provide a learning method of a spiking neural network operating with a low power and having improved accuracy, and a neural processor training the spiking neural network.

According to an embodiment, a learning method of a neural network which includes a first intermediate neuron layer and a second intermediate neuron layer may include performing first learning, which is based on a first synaptic weight layer, with respect to input subjects and the first intermediate neuron layer, determining intermediate neurons, which will perform second learning, from among intermediate neurons of the first intermediate neuron layer, based on the number of spikes of each of spike output signals of the intermediate neurons of the first intermediate neuron layer, and performing the second learning, which is based on a second synaptic weight layer, with respect to the intermediate neurons determined to perform the second learning.

According to an embodiment, a neural processor may perform first learning, which is based on a first synaptic weight layer, with respect to input subjects and a first intermediate neuron layer of a neural network including the first intermediate neuron layer and a second intermediate neuron layer, may determine intermediate neurons, which will perform second learning, from among intermediate neurons of the first intermediate neuron layer, based on the number of spikes of each of spike output signals of the intermediate neurons of the first intermediate neuron layer, and may perform the second learning, which is based on the second synaptic weight layer, with respect to the intermediate neurons determined to perform the second learning.

### BRIEF 15

The above and other objects and features of the present disclosure will become apparent by describing in detail embodiments thereof with reference to the accompanying drawings.

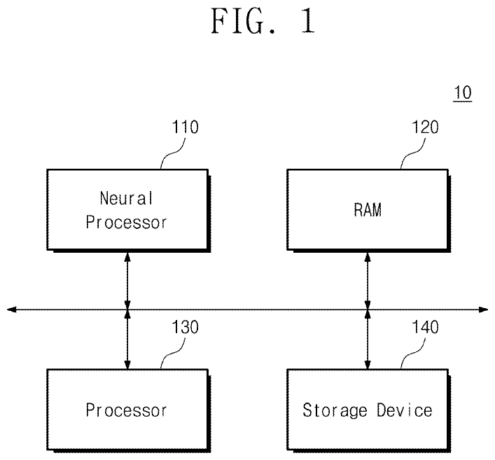

FIG. 1 illustrates a block diagram of an electronic device according to some embodiments of the present disclosure.

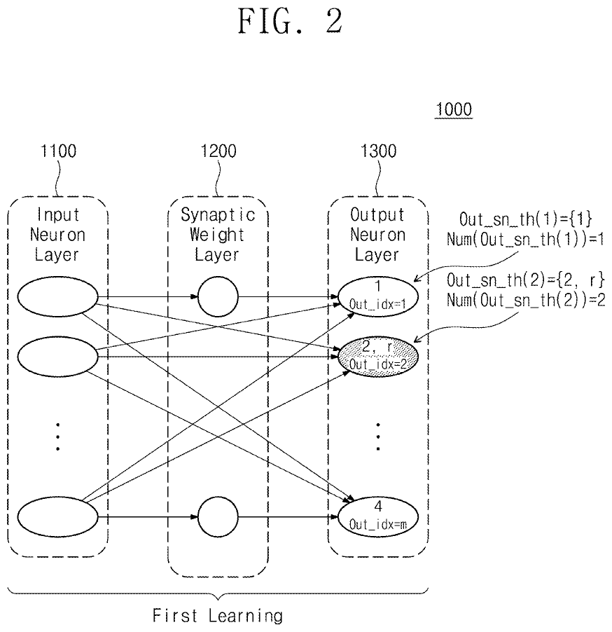

FIG. 2 illustrates a neural network according to some embodiments of the present disclosure.

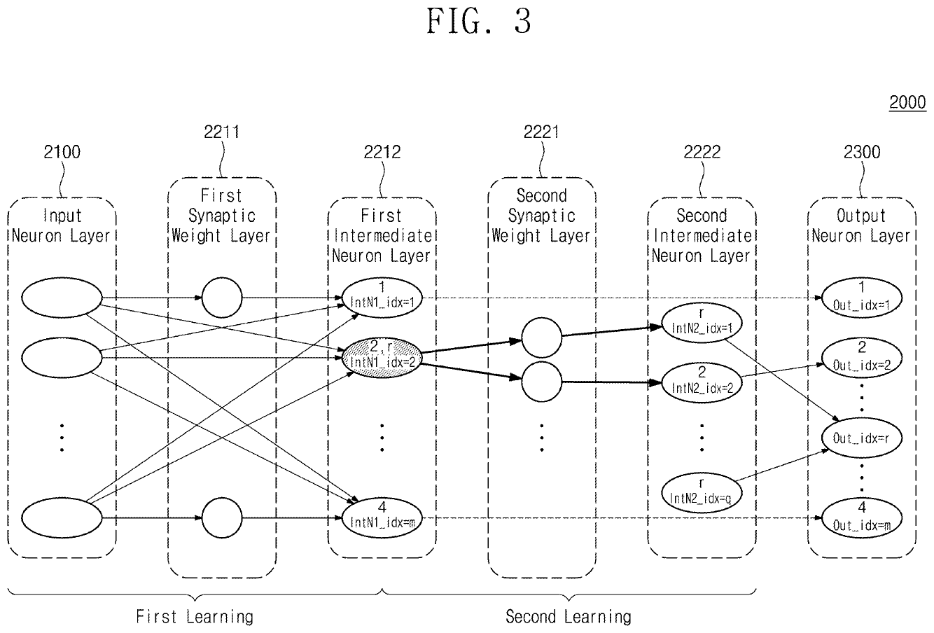

FIG. 3 illustrates a neural network according to some embodiments of the present disclosure.

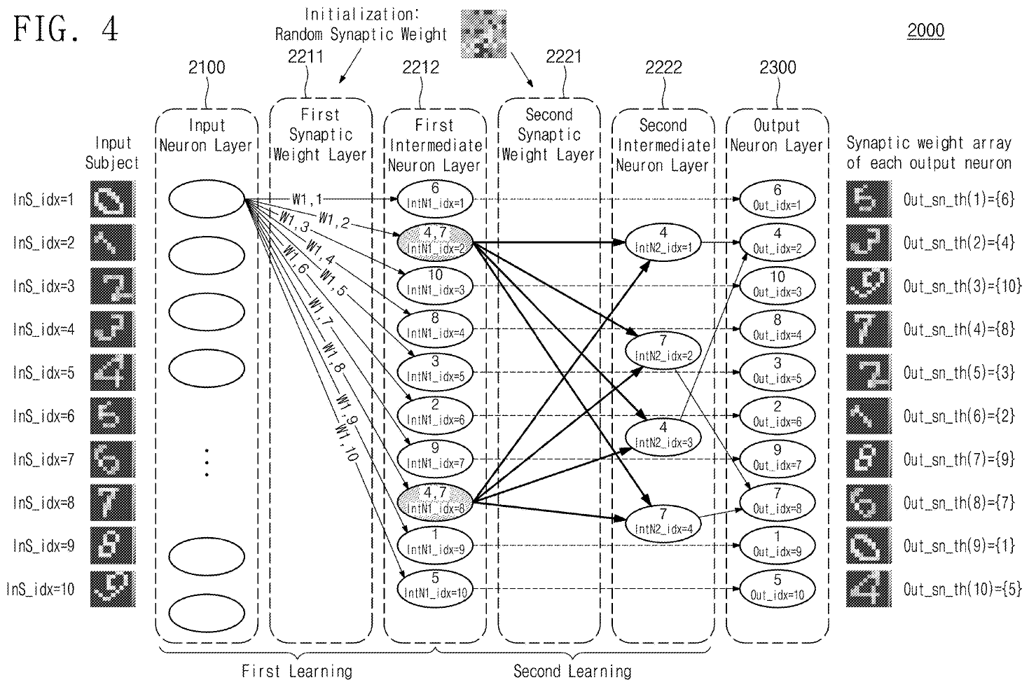

FIG. 4 illustrates a learning process of a neural network according to some embodiments of the present disclosure.

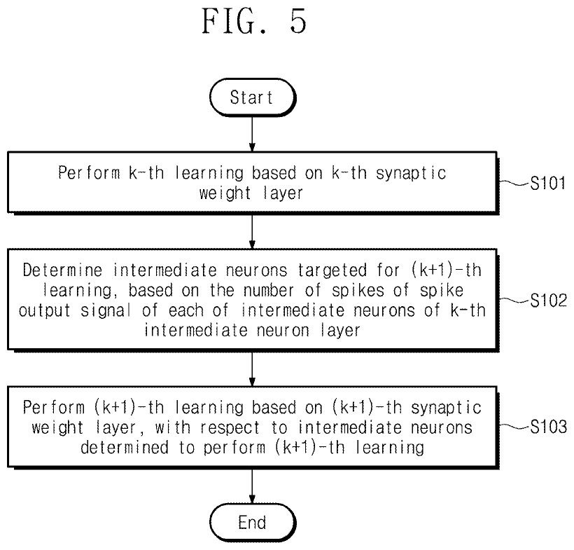

FIG. 5 illustrates a flowchart of a learning method of a neural network according to some embodiments of the present disclosure.

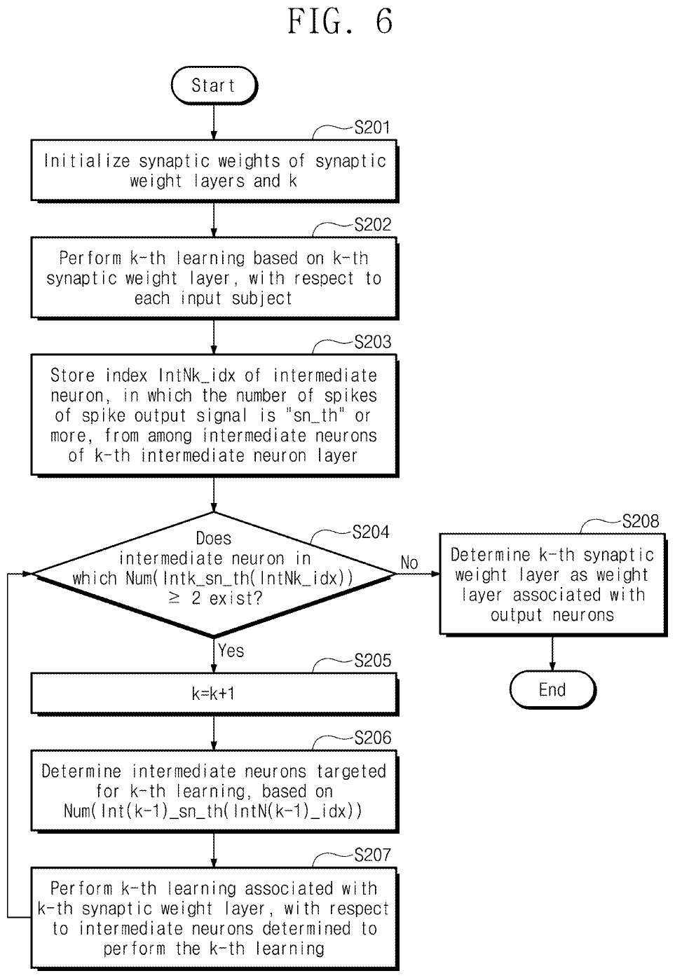

FIG. 6 illustrates a flowchart of a learning method of a neural network according to some embodiments of the present disclosure.

### DETAILED DESCRIPTION

Below, embodiments of the present disclosure may be described in detail and clearly to such an extent that an ordinary one in the art easily implements the invention.

Hereinafter, the best embodiment of the present disclosure will be described in detail with reference to accompanying drawings. With regard to the description of the present disclosure, to make the overall understanding easy, like components will be marked by like reference signs/numerals in drawings, and thus, additional description will be omitted to avoid redundancy.

FIG. 1 illustrates a block diagram of an electronic device 10 according to some embodiments of the present disclosure. Referring to FIG. 1, the electronic device 10 may include a neural processor (or a neural processing unit) 110, a random access memory (RAM) 120, a processor 130, and a storage device 140.

Under control of the processor 130, the neural processor 110 may perform an inference operation based on various neural network algorithms. For example, the neural processor 110 may perform various operations based on a spiking neural network (SNN). The neural processor 110 may include an operator or an accelerator for processing neural network-based computations. The neural processor 110 may receive various kinds of input data from the RAM 120 or the storage device 140, and may train a neural network (e.g., a neural network 1000 of FIG. 2 or a neural network 2000 of FIG. 3) based on the received input data.

The RAM 120 may store data to be processed by the neural processor 110 or the processor 130, various program codes or instructions executable by the neural processor 110 or the processor 130, or data processed by the neural processor 110 or the processor 130. The RAM 120 may include a static random access memory (SRAM) or a dynamic random access memory (DRAM).

The processor 130 may perform various computations/calculations necessary for an operation of the electronic device 10. For example, the processor 130 may execute firmware, software, or program codes loaded onto the RAM 120. The processor 130 may control the electronic device 10 by executing the firmware, software, or program codes loaded onto the RAM 120. The processor 130 may store execution results in the RAM 120 or the storage device 140.

The storage device 140 may store data or information necessary for the neural processor 110 or the processor 130 to perform computations/calculations. The storage device 140 may store data processed by the neural processor 110 or the processor 130. The storage device 140 may store software, firmware, a program code, or instructions that are executable by the neural processor 110 or the processor 130. The storage device 140 may include a volatile memory such as an SRAM or a DRAM, or a nonvolatile memory such as a flash memory.

In some embodiments, the neural processor 110 may perform first learning based on a first synaptic weight layer, with respect to input subjects and a first intermediate neuron layer of a neural network including the first intermediate neuron layer and a second intermediate neuron layer. The neural processor 110 determine intermediate neurons, which will perform second learning, from among intermediate neurons of the first intermediate neuron layer, based on the number of spikes of each of spike output signals of the intermediate neurons of the first intermediate neuron layer. The neural processor 110 may perform the second learning based on a second synaptic weight layer, with respect to the intermediate neurons determined to perform the second learning. As such, the speed and accuracy of learning of the neural network may be improved.

In some embodiments, the first learning and the second learning may be performed by a spike-timing-dependent plasticity (STDP) algorithm.

In some embodiments, the neural processor 110 may initialize synaptic weight layers included in the neural network and may perform the first learning by performing at least one epoch with respect to the input subjects. For example, the neural processor 110 may perform the epoch as many as the given number of times (e.g., once or more).

In some embodiments, the neural processor 110 may store an index of a first intermediate neuron, in which the number of spikes of a spike output signal is a threshold value or more, from among the intermediate neurons of the first intermediate neuron layer. The neural processor 110 may determine the number of input subjects, which allow the first intermediate neuron to output a spike output signal including spikes, the number of which is the threshold value or more, from among the input subjects. The neural processor 110 may determine whether to perform the second learning with respect to the first intermediate neuron, based on the number of input subjects thus determined. In response to that the number of input subjects thus determined is “1”, the neural processor 110 may determine that there is no need to perform the second learning with respect to the first intermediate neuron; in response to that the number of input subjects thus determined is 2 or more, the neural processor 110 may determine that there is a need to perform the second learning with respect to the first intermediate neuron.

In some embodiments, the neural processor 110 may determine input subjects, whose learning is not completed in the first learning, from among the input subjects, based on the intermediate neurons determined to perform the second learning. The neural processor 110 may determine the number of intermediate neurons included in the second intermediate neuron layer, based on the number of input subjects whose learning is not completed in the first learning. The number of intermediate neurons included in the second intermediate neuron layer may be equal to or more than the number of input subjects whose learning is not completed in the first learning. The neural processor 110 may initialize synaptic weight values of the intermediate neurons of the first synaptic weight layer, which are determined to perform the second learning with respect to the input subjects whose learning is not completed in the first learning. The neural processor 110 may perform the second learning with respect to the partially initialized first synaptic weight layer, the input subjects whose learning is not completed in the first learning, and the intermediate neurons of the second intermediate neuron layer.

In some embodiments, the neural processor 110 determine intermediate neurons, which will perform third learning, from among the intermediate neurons of the second intermediate neuron layer, based on the number of spikes of each of spike output signals of the intermediate neurons of the second intermediate neuron layer. The neural processor 110 may allow the third learning not to be performed, in response to that each of the intermediate neurons of the second intermediate neuron layer corresponds to only one of the input subjects. The neural processor 110 may determine the second synaptic weight layer as a weight layer associated with output neurons.

FIG. 2 illustrates the neural network 1000 according to some embodiments of the present disclosure. Referring to FIGS. 1 and 2, the neural processor 110 of FIG. 1 may train the neural network 1000, based on input data. The neural network 1000 may be a spiking neural network.

The neural network 1000 may include an input neuron layer 1100, a synaptic weight layer 1200, and an output neuron layer 1300. The neural processor 110 may perform neural network operations with respect to input subjects (or input data) and may generate output data based on a computing result.

The input neuron layer 1100 may include one or more input neurons, and the output neuron layer 1300 may include one or more output neurons. The synaptic weight layer 1200 may include synaptic weights capable of determining connection strengths between the input neurons and the output neurons. One input neuron may be connected with all output neurons through synapses. The input neuron may transfer a spike signal to each output neuron, based on a value of a relevant synaptic weight.

The input neurons may receive information about an input subject as a spike signal. When a membrane potential reaches a threshold value, an input neuron may fire, that is, may output a spike signal. For example, the input neuron may transfer a signal to a relevant output neuron in the form of a pulse toggling for a short time. In some embodiments, in the case where an output signal of an input neuron is an electrical signal, a membrane potential of the input neuron may be the strength of the electrical signal.

In some embodiments, the neural processor 110 may train the neural network 1000 by performing computations based on the spike-timing-dependent plasticity (STDP) algorithm. That an arbitrary output neuron is trained with respect to an arbitrary input subject may mean that synaptic weights of the output neuron have great correlation values by the spike signal of the input subject. For example, during a time period in which a spike signal associated with the input subject is generated, on connection paths between input neurons and the output neurons, whether a spike of a spike output signal occurs may be determined depending on whether a value, which is obtained by performing the convolution on 1) a value determined based on whether a spike signal is present on one connection path and 2) a synaptic weight of the connection path, exceeds a threshold value. When the value obtained through the convolution exceeds the threshold value for determining whether to output a spike, a spike of the spike output signal may occur. In this case, when the spike of the spike output signal occurs as many as “sn_th” (sn_th being a natural number) times (e.g., when the spike output signal includes “sn_th” spikes), the output neuron may be determined as being trained with respect to the input subject. In an embodiment, “sn_th” may be a threshold value of the number of spike output signals corresponding to one input subject.

In the illustrated embodiment, first, the first learning may be performed on the neural network 1000. For example, as the epoch is performed one or more times, the first learning may be performed. Before the first learning is performed, all synaptic weights may be initialized to have a random value within a given range.

As the first learning is performed, a learning process may be performed with respect to all input subjects. For example, spike input signals associated with each of input subjects may be once input to the input neuron. The spike input signals input to each input neuron may be randomly generated in compliance with a given rule. Spike input signals corresponding to one input subject may be composed of consecutive spike signals including feature information for distinguishing between the input subjects. For example, within a given time period associated with a corresponding input subject, spike signals defined in compliance with the given rule may be input to the input neurons at random time intervals. As such, spike output signals may be transferred to the output neurons, based on values of synaptic weights of a synaptic weight layer.

Synaptic weights may be trained such that one of the input subjects is identified by spike input signals. Whether an output neuron is trained with respect to any input subject of a plurality of input subjects may be determined depending on the degree of correlation between 1) a random distribution characteristic of spike input signals of an input subject, which are respectively input to the input neurons, and 2) an initial random distribution characteristic of synaptic weights connected with a corresponding output neuron. When one output neuron is trained with respect to an input subject(s) in a one-to-one correspondence or in a one-to-many correspondence, it may be determined that the neural network 1000 is completely (or successfully) trained with respect to all the input subjects.

With regard to any one output neuron, “Out_sn_th” indicating a set of input subjects causing a spike output signal including “sn_th” or more spikes may be expressed by the following: Out_sn_th(Out_idx)={InS_idx}. Here, “Out_idx” may indicate an index of the output neuron, and “InS_idx” may indicate an index of an input subject that causes a spike output signal to occur as many as “sn_th” times or more. In each of the output neurons, when the number of input subjects causing “sn_th” or more spikes of a corresponding spike output signal is 2 or more, it may be determined that the learning of the corresponding input subjects is not completed (i.e., that the corresponding input subjects fail in learning). For example, when “Num(Out_sn_th(Out_idx))” indicating the number of elements of the set “Out_sn_th(Out_idx)” is greater than “1”, a corresponding output neuron may be determined as failing in learning due to crosstalk between input subjects.

In the illustrated embodiment, at a first output neuron in which “Out_idx” indicating an index of an output neuron is “1”, set “Out_sn_th(1)” may be {1}. “Num(Out_sn_th(1))” indicating the number of elements of set “Out_sn_th(1)” may be “1”. In other words, at the first output neuron, a spike of a spike output signal may occur as many as “sn_th” or more with regard to a first input subject but may not occur (or may occur as many as smaller than “sn_th”) with regard to the remaining input subjects. Accordingly, it may be determined that the learning of the first input subject is made with respect to the first output neuron. As in the above description, at an m-th output neuron (m being a natural number), because “Num(Out_sn_th(m))” indicating the number of elements of set “Out_sn_th(m)” is “1”, it may be determined that the learning of the fourth input subject is made with respect to the m-th output neuron.

In contrast, at a second output neuron (Out_idx=2), set “Out_sn_th(2)” may be {2, r}. “Num(Out_sn_th(2))” indicating the number of elements of set “Out_sn_th(2)” may be “2”. In other words, at the second output neuron, a spike output signal may occur as many as “sn_th” times or more at each of the second input subject and the r-th input subject. Accordingly, the second output neuron may be determined as being not trained with regard to the second input subject and the r-th input subject.

As it is determined that the second output neuron fails in learning, additional learning may be required. In the case where additional epoch learning is performed (e.g., in the case where all input subjects are again sequentially input to the input neurons of an input neuron layer 2100), a re-input of the second input subject and the r-th input subject whose learning is not completed may interfere in weights of the remaining output neurons that are completely trained in the first learning. For example, spike input signals of an input subject(s) whose learning is not completed may act as an interference signal at a plurality of intermediate neurons. As such, in the case where the second input subject and the r-th input subject whose learning is not completed are again input to the neural network 1000, a learning result of the remaining output neurons that are already completely trained may be distorted. As a result, an overall learning result of the neural network 1000 may be degraded.

FIG. 3 illustrates the neural network 2000 according to some embodiments of the present disclosure. Referring to FIGS. 1, 2, and 3, the neural processor 110 of FIG. 1 may train the neural network 2000, based on input data. The neural network 2000 may be a spiking neural network. In some embodiments, the neural processor 110 may train the neural network 2000 by performing computations based on the STDP algorithm.

Unlike the neural network 1000 of FIG. 2, the neural network 2000 may include a plurality of intermediate neuron layers. For example, the neural network 2000 may include the input neuron layer 2100, a first synaptic weight layer 2211, a first intermediate neuron layer 2212, a second synaptic weight layer 2221, a second intermediate neuron layer 2222, and an output neuron layer 2300. For convenience of illustration, the neural network 2000 includes two intermediate neuron layers 2212 and 2222, but the present disclosure is not limited thereto.

The input neuron layer 2100 may include one or more input neurons, and the output neuron layer 2300 may include one or more output neurons. Each of the first intermediate neuron layer 2212 and the second intermediate neuron layer 2222 may include one or more intermediate neurons. In the illustrated embodiment, the first intermediate neuron layer 2212 may include “m” intermediate neurons, the second intermediate neuron layer 2222 may include “q” intermediate neurons (q being a natural number), and the output neuron layer 2300 may include “m” output neurons, but the present disclosure is not limited thereto.

The first synaptic weight layer 2211 may include synaptic weights of connection paths between the input neurons of the input neuron layer 2100 and the intermediate neurons of the first intermediate neuron layer 2212. The second synaptic weight layer 2221 may include synaptic weights of connection paths between the intermediate neurons of the first intermediate neuron layer 2212 and the intermediate neurons of the second intermediate neuron layer 2222.

In the illustrated embodiment, as in the manner described with reference to FIG. 2, the first learning may be first performed on the neural network 2000, based on input subjects. For example, as the epoch is performed one or more times, the first learning may be performed. When the epoch is performed once, spike input signals corresponding to each of the input subjects may be input to the input neurons once.

With regard to an arbitrary intermediate neuron of a k-th intermediate neuron layer (k being a natural number), “Intk_sn_th” that is a set of indexes of input subjects and is based on the number of times of occurrence of a spike of a spike output signal may be expressed by the following: “Intk_sn_th(IntNk_idx)={InS_idx}”. Here, “IntNk_idx” may indicate an index of the intermediate neuron included in the k-th intermediate neuron layer, and “InS_idx” may indicate an index of an input subject that causes a spike output signal to occur as many as “sn_th” times or more.

As in the above description given with reference to FIG. 2, in each of the intermediate neurons of the k-th intermediate neuron layer, when the number of input subjects causing a spike output signal to occur “sn_th” times or more is 2 or more, it may be determined that the learning of the corresponding input subjects is not completed (i.e., that the corresponding input subjects fail in learning). For example, when “Num(Intk_sn_th(IntNk_idx))” indicating the number of elements of the set “Intk_sn_th(IntNk_idx)” is greater than “1”, a corresponding intermediate neuron may be determined as failing in learning due to crosstalk between input subjects.

In the illustrated embodiment, due to the first learning, at a first intermediate neuron of the first intermediate neuron layer 2212, in which index “IntN1_idx” is “1”, set “Int1_sn_th(1)” may be {1}. “Num(Int1_sn_th(1))” indicating the number of elements of set “Int1_sn_th(1)” may be “1”. In other words, at the first intermediate neuron of the first intermediate neuron layer 2212, a spike of a spike output signal may occur as many as “sn_th” or more with regard to a first input subject but may not occur (or may occur as many as smaller than “sn_th”) with regard to the remaining input subjects. Accordingly, it may be determined that the learning of the first input subject is made with respect to the first output neuron. As in the above description, at an m-th intermediate neuron of the first intermediate neuron layer 2212 (IntN1_idx=m), because “Num(Int1_sn_th(m))” indicating the number of elements of set “Int1_sn_th(m)” is “1”, it may be determined that the learning of the fourth input subject is made with respect to the m-th output neuron.

In contrast, at a second intermediate neuron of the first intermediate neuron layer 2212 (IntN1_idx=2), set “Int1_sn_th(2)” may be {2, r}. That is, “Num(Int1_sn_th(2))” indicating the number of elements of set “Int1_sn_th(2)” is “2”. In other words, at the second intermediate neuron of the first intermediate neuron layer 2212, a spike output signal may occur as many as “sn_th” times or more at each of the second input subject and the r-th input subject. Accordingly, the second output neuron may be determined as being not trained with regard to the second input subject and the r-th input subject.

After the first learning is performed, the neural processor 110 may determine intermediate neurons targeted for additional learning at the first intermediate neuron layer 2212, based on a result of the first learning. For example, like the second intermediate neuron of the first intermediate neuron layer 2212, the i-th intermediate neuron of the first intermediate neuron layer 2212, in which “Num(Int1_sn_th(i))” exceeds “1”, may be determined to perform the additional learning.

The neural processor 110 may determine whether to perform the second learning, by determining the number of intermediate neurons of the first intermediate neuron layer 2212, which are determined to perform the additional learning. For example, unlike the illustrated embodiment, in the case where the i-th intermediate neuron of the first intermediate neuron layer 2212, in which “Num(Int1_sn_th(i))” exceeds “1”, does not exist, the neural processor 110 may allow the second learning not to be performed and may terminate the learning. The trained first synaptic weight layer 2211 that determines an output of intermediate neurons of the first intermediate neuron layer 2212 may be determined as a synaptic weight layer of the output neuron layer 2300.

In the illustrated embodiment, because an i-th intermediate neuron of the first intermediate neuron layer 2212, in which “Num(Int1_sn_th(i))” exceeds “1”, exists (e.g., i=2), the neural processor 110 may determine to further perform the second learning in addition to the first learning. Based on the number of intermediate neurons of the first intermediate neuron layer 2212, which are determined to perform the second learning, the neural processor 110 may determine “q” (q being a natural number) being the number of intermediate neurons of the second intermediate neuron layer 2222 for performing the second learning. For example, the neural processor 110 may determine the number of input subjects whose learning is not completed and may determine the number “q” of intermediate neurons of the second intermediate neuron layer 2222, based on a determination result.

The difficulty of learning of the neural network 2000 may be determined depending on the amount of information capable of distinguishing from each other when transforming each input subject in the form of a spike signal. Therefore, the difficulty of learning may increase when the amount of information capable of distinguishing input subjects is small, when hyper parameter values associated with a learning process of determining the efficiency of learning are not appropriately determined, or when the number of intermediate neurons is not many enough to distinguish input subjects. As such, intermediate neurons failing in learning may occur, or a lot of time may be required to complete the learning. To secure the completion of learning or a fast speed of learning, the number “q” of intermediate neurons of the second intermediate neuron layer 2222 may be equal to or more than the number of input subjects failing in the first learning.

With regard to intermediate neurons of the first intermediate neuron layer 2212 satisfying the condition of “Num(Int1_sn_th(IntN1_idx))=1”, the neural processor 110 may determine an input subject having an index(es) not included in a union of sets Int1_sn_th(IntN1_idx), as an input subject whose learning is not completed in the first learning. For example, in the illustrated embodiment, because the condition of “Num(Int1_sn_th(1))=1” is satisfied, an index (1) of the first input subject may be included in the union of sets “Int1_sn_th(IntN1_idx)”. As in the above description, an index (4) of the fourth input subject may be included in the union of sets “Int1_sn_th(IntN1_idx)”. In contrast, with regard to the second intermediate neuron of the first intermediate neuron layer 2212, because the condition of “Num(Int1_sn_th(2))=1” is not satisfied, an index (2) of the second input subject and an index (r) of the r-th input subject may not be included in the union of sets “Int1_sn_th(IntN1_idx)”. Therefore, the neural processor 110 may determine the first input subject and the fourth input subject as input subjects trained in the first learning and may determine the second input subject and the r-th input subject as input subjects failing in learning in the first learning.

For example, in the illustrated embodiment, because at least the second input subject and the r-th input subject are determined as failing in learning in the first learning, the number of intermediate neurons of the second intermediate neuron layer 2222 may be at least 2.

The neural processor 110 may initialize synaptic weight values of intermediate neurons of the first intermediate neuron layer 2212, which are not trained by the first learning, and may perform the second learning. For example, values of synaptic weights of the first synaptic weight layer 2211, which are associated with intermediate neurons of the first intermediate neuron layer 2212 determined to perform additional learning (e.g., intermediate neurons of the first intermediate neuron layer 2212 satisfying the condition of “Num(Int1_sn_th(IntN1_idx)≥2”), may be again set to have a random value within the given range. Afterwards, the neural processor 110 may perform the second learning with respect to the second synaptic weight layer 2221, based on the first synaptic weight layer 2211 partially initialized and the intermediate neurons of the second intermediate neuron layer 2222.

For example, as the second learning is performed, the initialized synaptic weights of the first synaptic weight layer 2211 may be again trained to form the second synaptic weight layer 2221. Synaptic weights of the first synaptic weight layer 2211, which are associated with connection paths between the input neurons of the input neuron layer 2100 and the second intermediate neurons of the first intermediate neuron layer 2212 determined to perform the second learning may be associated with a corresponding connection path of connection paths between an second intermediate neuron of the first intermediate neuron layer 2212 and output intermediate neurons of the second intermediate neuron layer 2222.

After the second learning is performed, the neural processor 110 may determine intermediate neurons targeted for additional learning at the second intermediate neuron layer 2222, based on a result of the second learning. For example, as in the above description given with regard to the first intermediate neuron layer 2212, a j-th intermediate neuron (j being an arbitrary natural number) of the second intermediate neuron layer 2222, in which “Num(Int2_sn_th(j))” exceeds “1”, may be determined to perform the additional learning.

The neural processor 110 may determine whether to perform the third learning, by determining the number of intermediate neurons of the second intermediate neuron layer 2222, which are determined to perform the additional learning. For example, in the case where the j-th intermediate neuron of the second intermediate neuron layer 2222, in which “Num(Int2_sn_th(j))” exceeds “1”, does not exist, each of the intermediate neurons of the second intermediate neuron layer 2222 may be determined as trained to correspond to one input subject. As such, the neural processor 110 may allow the third learning not to be performed and may terminate the learning. In this case, the trained second synaptic weight layer 2221 that determines an output of intermediate neurons of the second intermediate neuron layer 2222 may be determined as a synaptic weight layer of the output neuron layer 2300. The neural network 2000 may be used as a spiking neural network whose learning is completed, based on the second synaptic weight layer 2221.

In the illustrated embodiment, the condition of “Num(Int2_sn_th(IntN2_idx))=1” may be satisfied with regard to all the intermediate neurons of the second intermediate neuron layer 2222. As such, the neural processor 110 may determine that addition learning is not required. The neural processor 110 may determine the trained second synaptic weight layer 2221, which determines an output of intermediate neurons of the second intermediate neuron layer 2222, as a synaptic weight layer of the output neurons of the output neuron layer 2300. Afterwards, the neural processor 110 may terminate the learning of the neural network 2000.

Instead of performing additional learning with respect to all input subjects, the neural processor 110 may perform retraining only with respect to input subjects whose learning is not completed in a preceding learning, based on the neural network 2000 including multiple intermediate neuron layers. For example, a (k+1)-th learning associated with a (k+1)-th intermediate neuron layer and a (k+1)-th synaptic weight layer may be performed only with respect to input subjects whose learning is not completed in a k-th learning associated with a k-th intermediate neuron layer and a k-th synaptic weight layer. As such, a result of the k-th learning may be prevented from being distorted due to a re-input of input subjects whose learning is not completed.

Only synaptic weights, which are associated with intermediate neurons determined to perform the (k+1)-th learning of the k-th intermediate neuron layer, from among synaptic weights of the k-th synaptic weight layer may be initialized and may be trained in the (k+1)-th learning. In this case, the number of intermediate neurons of the (k+1)-th intermediate neuron layer (e.g., the number of intermediate neurons, the synaptic weights of which are initialized, from among intermediate neurons of the (k+1)-th intermediate neuron layer) may be equal to or more than the number of input subjects whose learning is not completed through the k-th learning. As such, in the case where crosstalk between input subjects whose information amounts are not enough to distinguish from each other occurs, the performance with which input subjects are distinguished from each other may be improved as the number of intermediate neurons increases.

FIG. 4 illustrates a learning process of the neural network 2000 according to some embodiments of the present disclosure. Referring to FIGS. 1 to 4, a process in which the neural network 2000 of FIG. 3 is trained as 10*10 pixel input subjects of a number shape are input will be described as an embodiment. In the embodiment illustrated in FIG. 4, it is assumed that the number of intermediate neuron layers 2212 and 2222 is 2, the number of input neurons of the input neuron layer 2100 is 100, the number of intermediate neurons of the first intermediate neuron layer 2212 is 10, the number of intermediate neurons of the second intermediate neuron layer 2222 is 4, and the number of output neurons of the output neuron layer 2300 is 10. However, this is for convenience of description, and the present disclosure is not limited to this example.

Each of the first to tenth input subjects that respectively correspond to shapes of number 0 to number 9 may be composed of 10*10 pixels, that is, 100 pixels. For example, in the illustrated embodiment, a first input subject of index “1” (InS_idx=1) may correspond to number 0.

The first to tenth input subjects may be sequentially input to the 100 input neurons as spike input signals randomly distributed during a given time period based on information corresponding to each of the 100 pixels. The number of spikes of a spike input signal corresponding to one pixel of the 100 pixels of one input subject may be determined to include information available to distinguish between different input subjects, such as a value of an intensity of the one pixel or a change in an intensity value between the one pixel and pixels adjacent to the one pixel. An interval between spikes included in one spike input signal may be determined depending on a Poisson distribution. For example, a spike input signal corresponding to a first pixel of the 100 pixels of the first input subject may include spike signals randomly distributed during a given time period based on information corresponding to the first pixel. The spike input signal corresponding to the first pixel of the 100 pixels of the first input subject may be input to a first input neuron.

Each of the input neurons of the input neuron layer 2100 may be connected with all intermediate neurons of the first intermediate neuron layer 2212. For example, the first input neuron of the input neuron layer 2100 may be connected with first to tenth intermediate neurons IntN1_idx=1 to IntN1_idx=10 of the first intermediate neuron layer 2212. Each of the connections may be associated with a corresponding synaptic weight, and a value of the synaptic weight may be determined through the first learning. For example, the first input neuron may be connected with the first intermediate neuron of the first intermediate neuron layer 2212 based on a synaptic weight of “W1,1” and may be connected with the second intermediate neuron of the first intermediate neuron layer 2212 based on a synaptic weight of “W1,2”. In other words, a j-th input neuron and an 1-th intermediate neuron of the first intermediate neuron layer 2212 may be connected based on a synaptic weight of “Wj,l” (j being a natural number of 100 or less, and “1” being a natural number of 10 or less).

Before the first learning is performed, first, synaptic weights of the first synaptic weight layer 2211 may be initialized to a random value within a given range. Afterwards, as the epoch is performed once, all spike input signals corresponding to the first to tenth input subjects may be sequentially input to the input neurons of the input neuron layer 2100. That is, the first learning may be performed.

As the first learning is performed, values of the synaptic weights of the first synaptic weight layer 2211 may be determined, and a spike output signal may occur at each of the intermediate neurons of the first intermediate neuron layer 2212. An intermediate neuron in which the number of input subjects each causing a spike output signal including “sn_th” or more spikes is “1” may be determined as the corresponding input subject is trained. In contrast, an intermediate neuron in which the number of input subjects each causing a spike output signal including “sn_th” or more spikes is 2 or more may be determined as failing in learning due to crosstalk between input subjects.

For example, in the illustrated embodiment, at the first intermediate neuron IntN1=idx1 of the first intermediate neuron layer 2212, “sn_th” or more spikes may occur only with regard to the sixth input subject (e.g., Int1_sn_th(1)={6}). Therefore, the first intermediate neuron of the first intermediate neuron layer 2212 may be determined as trained with regard to the sixth input subject (i.e., a shape corresponding to number 5). As in the above description, the third to seventhintermediate neurons, ninth intermediate neuron, and the tenth intermediate neuron of the first intermediate neuron layer 2212 may be determined as trained with regard to the tenth input subject, the eighth input subject, the third input subject, the second input subject, the ninth input subject, the first input subject, and the fifth input subject.

In contrast, at the second intermediate neuron and the eighth intermediate neuron of the first intermediate neuron layer 2212, the number of input subjects causing “sn_th” or more spikes may be 2 (e.g., Int1_sn_th(2)={4, 7} and Int1_sn_th(8)={4, 7}). Therefore, at the second intermediate neuron and the eighth intermediate neuron of the first intermediate neuron layer 2212, it may be confirmed that the learning fails due to crosstalk between a shape corresponding to number 3 (i.e., the fourth input subject) and a shape corresponding to number 6 (i.e., the seventh input subject).

After the first learning is performed, the neural processor 110 may determine intermediate neurons targeted for additional learning at the first intermediate neuron layer 2212, based on a result of the first learning. For example, the condition of “Num(Int1_sn_th(2))≥2” may be satisfied at the second intermediate neuron of the first intermediate neuron layer 2212, and the condition of “Num(Int1_sn_th(8))≥2” may be satisfied at the eighth intermediate neuron of the first intermediate neuron layer 2212. Accordingly, the second learning may be determined so as to be performed with regard to the second intermediate neuron and the eighth intermediate neuron of the first intermediate neuron layer 2212.

Based on the number of intermediate neurons of the first intermediate neuron layer 2212, which are determined to perform the second learning, the neural processor 110 may determine the number of intermediate neurons of the second intermediate neuron layer 2222 for performing the second learning. For example, with regard to intermediate neurons (e.g., the third to seventhintermediate neurons, the ninth intermediate neuron, and the tenth intermediate neuron) of the first intermediate neuron layer 2212 satisfying “Num(Int1_sn_th(IntN1_idx))=1”, the union of sets “Int1_sn_th(IntN1_idx)” may be {1, 2, 3, 5, 6, 8, 9, 10}. The neural processor 110 may determine the first to third, fifth, sixth, and eighth to tenth input subjects included in the union as input subjects trained in the first learning and may determine the fourth input subject and the seventh input subject as input subjects failing in learning in the first learning.

The neural processor 110 may determine the number of intermediate neurons of the second intermediate neuron layer 2222 so as to be equal to or more than the number of input subjects whose learning is not completed in the first learning. For example, in the illustrated embodiment, the neural processor 110 may determine the number of intermediate neurons of the second intermediate neuron layer 2222 as “4”, based on that the number of input subjects whose learning is not completed in the first learning is “2”.

The neural processor 110 may initialize synaptic weight values of the second and eighth intermediate neurons of the first intermediate neuron layer 2212, which are not trained by the first learning, and may perform the second learning. For example, values of synaptic weights (e.g., W1,2, W2,2, . . . , W100,2, W1,8, W2,8, . . . , W100,8) of the first synaptic weight layer 2211, which are connected with either the second intermediate neuron or the eighth intermediate neuron of the first intermediate neuron layer 2212, may be again set to have a random value within the given range. Afterwards, the initialized synaptic weights may be again trained by using the first to fourth intermediate neurons (e.g., IntN2_idx=1 to IntN2_idx=4) of the second intermediate neuron layer 2222.

For example, as the second learning is performed, the initialized synaptic weights of the first synaptic weight layer 2211 may be again trained to form the second synaptic weight layer 2221. The synaptic weights initialized for the second learning may be associated with a corresponding connection path of connection paths between the second or eighth intermediate neuron of the first intermediate neuron layer 2212 and intermediate neurons of the second intermediate neuron layer 2222. For example, each of initialized synaptic weights (e.g., W1,2, W2,2 . . . W100,2) associated with the second intermediate neuron of the first intermediate neuron layer 2212 may be associated with one of four connection paths between the second intermediate neuron of the first intermediate neuron layer 2212 and the first to fourth intermediate neurons of the second intermediate neuron layer 2222.

After the second learning is performed, the neural processor 110 may determine intermediate neurons targeted for additional learning at the second intermediate neuron layer 2222, based on a result of the second learning. In the illustrated embodiment, the condition of “Num(Int2_sn_th(IntN2_idx))=1” may be satisfied with regard to the first to fourth intermediate neurons of the second intermediate neuron layer 2222. Therefore, the neural processor 110 may determine that there is no need to perform additional learning (e.g., the third learning) associated with the first to fourth intermediate neurons of the second intermediate neuron layer 2222.

The neural processor 110 may determine the trained second synaptic weight layer 2221, which determines an output of the first to fourth intermediate neurons of the second intermediate neuron layer 2222, as a synaptic weight layer of the output neurons of the output neuron layer 2300. Afterwards, the neural processor 110 may terminate the learning of the neural network 2000. As the first learning and the second learning are performed, from synaptic weight arrays of the first to tenth output neurons (e.g., Out_idx=1 to Out_idx=10) of the output neuron layer 2300, it may be confirmed that one input subject is trained with regard to one output neuron. In some embodiments, two or more intermediate neurons causing a spike output signal including “sn_th” or more spikes with respect to one input subject may exist. In this case, the two or more intermediate neurons may be used to identify the one input subject.

FIG. 5 illustrates a flowchart of a learning method of the neural network 2000 according to some embodiments of the present disclosure. Referring to FIGS. 1 to 5, the neural network 2000 may be trained as operation S101 to operation S103 are performed by the neural processor 110.

In operation S101, the neural processor 110 may perform k-th learning based on a k-th synaptic weight layer. For example, when “k” is 1, the neural processor 110 may train the k-th synaptic weight layer by performing one epoch with respect to all input subjects and a k-th intermediate neuron layer. For another example, when “k” is an integer of 2 or more, based on intermediate neurons of a (k−1)-th intermediate neuron layer, which are determined based on (k−1)-th learning so as to perform the k-th learning, and the input subjects, the neural processor 110 may initialize synaptic weights associated with the intermediate neurons of the (k−1)-th synaptic weight layer and may train the k-th synaptic weight layer.

In operation S102, the neural processor 110 may determine intermediate neurons, which will perform (k+1)-th learning, based on the number of spikes of a spike output signal of each of the intermediate neurons of the k-th intermediate neuron layer. For example, when 2 or more input subjects each causing a spike output signal including spikes, the number of which is equal to or more than a threshold value “sn_th” are present at a first intermediate neuron of the k-th intermediate neuron layer, the first intermediate neuron of the k-th intermediate neuron layer may be determined to perform the (k+1)-th learning. For example, when one input subject causing a spike output signal including spikes, the number of which is equal to or more than a threshold value “sn_th” are present at a second intermediate neuron of the k-th intermediate neuron layer, the second intermediate neuron of the k-th intermediate neuron layer may be determined not to perform the (k+1)-th learning.

In operation S103, the neural processor 110 may perform the (k+1)-th learning based on a (k+1)-th synaptic weight layer, with respect to the intermediate neurons determined in operation S102 so as to perform the (k+1)-th learning. Based on intermediate neurons of the k-th intermediate neuron layer, which are determined based on the k-th learning so as to perform the (k+1)-th learning, and the input subjects, the neural processor 110 may initialize synaptic weights associated with the intermediate neurons of the k-th synaptic weight layer and may train the (k+1)-th synaptic weight layer.

In some embodiments, the k-th learning and the (k+1)-th learning may be performed by the STDP algorithm.

FIG. 6 illustrates a flowchart of a learning method of the neural network 2000 according to some embodiments of the present disclosure. Referring to FIGS. 1 to 6, the neural network 2000 may be trained as operation S201 to operation S208 are performed by the neural processor 110.

In operation S201, the neural processor 110 may initialize synaptic weights of synaptic weight layers and “k”. For example, the neural processor 110 may again set each of weights of synaptic weight layers (e.g., the first synaptic weight layer 2211 and the second synaptic weight layer 2221) included in the neural network 2000 depending on a random distribution and may again set “k” to “1”.

In operation S202, the neural processor 110 may perform the k-th learning based on the k-th synaptic weight layer, with respect to each input subject. For example, the neural processor 110 may perform the k-th learning (i.e., the first learning) by performing at least one epoch (e.g., the epoch as many as the given number of times) with respect to all the input subjects based on the k-th synaptic weight layer. The number of intermediate neurons of the k-th intermediate neuron layer associated with the k-th synaptic weight layer may be equal to or more than the number of input subjects.

In operation S203, the neural processor 110 may store an index IntNk_idx of an intermediate neuron, in which the number of spikes of a spike output signal is “sn_th” or more, from among the intermediate neurons of the k-th intermediate neuron layer. “IntNk_idx” may indicate an index of intermediate neurons of the k-th intermediate neuron layer. At a z-th intermediate neuron in which IntNk_idx=z, in the case where indexes InS_idx of input subjects each causing a spike output signal including “sn_th” or more spikes are “x” and “y”, a set Intk_sn_th(z) of the input subjects each causing a spike output signal including “sn_th” or more spikes at the z-th intermediate neuron of the k-th intermediate neuron layer may be expressed by {x, y}.

In operation S204, the neural processor 110 may determine whether an intermediate neuron in which Num(Intk_sn_th(IntNk_idx))≥2 exists. For example, the neural processor 110 may determine whether there is “IntNk_idx” at which the number of elements of set “Intk_sn_th(IntNk_idx)” is 2 or more.

When an intermediate neuron in which Num(Intk_sn_th(IntNk_idx))≥2 exists, in operation S205, the neural processor 110 may increase a value “k” as many as “1”.

In operation S206, the neural processor 110 may determine intermediate neurons targeted for the k-th learning, based on “Num(Int(k−1)_sn_th(IntN(k−1)_idx))”. For example, the neural processor 110 may allow the k-th learning not to be performed with respect to intermediate neurons, each of which has an index satisfying “Num(Int(k−1)_sn_th(IntN(k−1)_idx))=1”, from among the intermediate neurons of the (k−1)-th intermediate neuron layer. For example, the neural processor 110 may allow the k-th learning to be performed with respect to intermediate neurons, each of which has an index satisfying “Num(Int(k−1)_sn_th(IntN(k−1)_idx))≥2”, from among the intermediate neurons of the (k−1)-th intermediate neuron layer. The neural processor 110 may determine that the learning for input subjects of indexes InS_idx not included in the union of sets Int(k−1)_sn_th(IntN(k−1)_idx) associated with indexes satisfying “Num(Int(k−1)_sn_th(IntN(k−1)_idx))=1” is not yet completed.

In operation S207, the neural processor 110 may perform the k-th learning associated with the k-th synaptic weight layer, with respect to the intermediate neurons determined to perform the k-th learning. For example, the neural processor 110 may initialize, to a random value, synapse weight values of intermediate neurons associated with input subjects whose learning is not yet completed, that is, determined in operation S206 so as to perform the k-th learning. Afterwards, the neural processor 110 may perform learning of synapse weights of the k-th synaptic weight layer, which correspond to the intermediate neurons of the k-th intermediate neuron layer. The k-th synaptic weight layer may determine an output of the intermediate neurons of the k-th intermediate neuron layer. In this case, the number of intermediate neurons of the k-th intermediate neuron layer may be equal to or more than the number of input subjects associated with the intermediate neurons determined in operation S206 as not yet trained.

After operation S207 is performed, the neural processor 110 may again perform operation S204. When an intermediate neuron in which Num(Intk_sn_th(IntNk_idx))≥2 exists, the neural processor 110 may again perform operation S205 to operation S207. For example, the neural processor 110 may increase a value of “k” as many as “1” and may again perform k-th learning. When an intermediate neuron in which Num(Intk_sn_th(IntNk_idx))≥2 does not exist, the neural processor 110 may perform operation S208. For example, in the case where one input subject causing an output of “sn_th” or more spikes exists at each of the intermediate neurons of the k-th intermediate neuron layer, the neural processor 110 may perform operation S208.

In operation S208, the neural processor 110 may determine the k-th synaptic weight layer as a weight layer associated with output neurons. The neural processor 110 may terminate the learning of the neural processor 110, and may use, as synaptic weights of the output neurons, synaptic weights included in the k-th synaptic weight layer connected with the k-th intermediate neuron layer used in the k-th learning being the last learning. Afterwards, the neural network 2000 may be used as a neural network that completes the learning of given input subjects.

In some embodiments, as well as the neural processor 110, the processor 130 may also perform operation S101 to operation S103 of FIG. 5 and operation S201 to operation S208 of FIG. 6. For example, the processor 130 may execute program codes or instructions for the learning of neural network 2000.

A neural network according to an embodiment of the present disclosure may include a plurality of intermediate neuron layers. Retraining may be performed with respect to input subjects whose learning is not completed in previous learning, based on a next intermediate neuron layer in next learning. In this case, the number of intermediate neurons of the next intermediate neuron layer may be equal to or more than the number of input subjects whose learning is not completed. Accordingly, a learning method of a neural network capable of improving the efficiency of learning and a neural processor using the learning method may be provided.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A learning method of a neural network which includes a first intermediate neuron layer and a second intermediate neuron layer, the method comprising:
performing first learning, which is based on a first synaptic weight layer, with respect to input subjects and the first intermediate neuron layer;
determining intermediate neurons, which will perform second learning, from among intermediate neurons of the first intermediate neuron layer, based on the number of spikes of each of spike output signals of the intermediate neurons of the first intermediate neuron layer; and
performing the second learning, which is based on a second synaptic weight layer, with respect to the intermediate neurons determined to perform the second learning.

2. The method of claim 1, wherein the first learning and the second learning are performed by a spike-timing-dependent plasticity (STDP) algorithm.

3. The method of claim 1, wherein the performing first learning includes:
initializing synaptic weight layers included in the neural network; and
performing at least one epoch with respect to the input subjects.

4. The method of claim 1, wherein the determining intermediate neurons, which will perform the second learning, from among the intermediate neurons of the first intermediate neuron layer includes:
storing an index of a first intermediate neuron, in which the number of spikes of a spike output signal is a threshold value or more, from among the intermediate neurons of the first intermediate neuron layer;
determining the number of input subjects, which allow the first intermediate neuron to output a spike output signal including spikes, the number of which is the threshold value or more, from among the input subjects; and
determining whether to perform the second learning with respect to the first intermediate neuron, based on the number of input subjects thus determined.

5. The method of claim 4, wherein the determining whether to perform the second learning with respect to the first intermediate neuron based on the number of input subjects thus determined includes:
allowing the second learning not to be performed with respect to the first intermediate neuron in response to that the number of input subjects thus determined is “1”; and
allowing the second learning to be performed with respect to the first intermediate neuron in response to that the number of input subjects thus determined is 2 or more.

6. The method of claim 1, wherein the performing second learning, which is based on the second synaptic weight layer, with respect to the intermediate neurons determined to perform the second learning includes:
determining input subjects, whose learning is not completed in the first learning, from among the input subjects, based on the intermediate neurons determined to perform the second learning; and
determining the number of intermediate neurons included in the second intermediate neuron layer, based on the number of input subjects whose learning is not completed in the first learning.

7. The method of claim 6, wherein the number of intermediate neurons included in the second intermediate neuron layer is equal to or more than the number of input subjects whose learning is not completed in the first learning.

8. The method of claim 6, wherein the performing of the second learning, which is based on the second synaptic weight layer, with respect to the intermediate neurons determined to perform the second learning includes:
initializing synaptic weight values of the intermediate neurons of the first synaptic weight layer, which are determined to perform the second learning with respect to the input subjects whose learning is not completed in the first learning; and
performing the second learning with respect to the partially initialized first synaptic weight layer, the input subjects whose learning is not completed in the first learning, and the intermediate neurons of the second intermediate neuron layer.

9. The method of claim 1, further comprising:
determining intermediate neurons, which will perform third learning, from among intermediate neurons of the second intermediate neuron layer, based on the number of spikes of each of spike output signals of the intermediate neurons of the second intermediate neuron layer.

10. The method of claim 9, further comprising:
allowing the third learning not to be performed, in response to that each of the intermediate neurons of the second intermediate neuron layer corresponds to only one of the input subjects; and
determining the second synaptic weight layer as a weight layer associated with output neurons.

11. A neural processor which is configured to:
perform first learning, which is based on a first synaptic weight layer, with respect to input subjects and a first intermediate neuron layer of a neural network including the first intermediate neuron layer and a second intermediate neuron layer;
determining intermediate neurons, which will perform second learning, from among intermediate neurons of the first intermediate neuron layer, based on the number of spikes of each of spike output signals of the intermediate neurons of the first intermediate neuron layer; and
performing the second learning, which is based on a second synaptic weight layer, with respect to the intermediate neurons determined to perform the second learning.

12. The neural processor of claim 11, wherein the first learning and the second learning are performed by a spike-timing-dependent plasticity (STDP) algorithm.

13. The neural processor of claim 11, wherein the neural processor is further configured to:
initialize synaptic weight layers included in the neural network; and
perform at least one epoch with respect to the input subjects.

14. The neural processor of claim 11, wherein the neural processor is further configured to:
store an index of a first intermediate neuron, in which the number of spikes of a spike output signal is a threshold value or more, from among the intermediate neurons of the first intermediate neuron layer;
determine the number of input subjects, which allow the first intermediate neuron to output a spike output signal including spikes, the number of which is the threshold value or more, from among the input subjects; and
determine whether to perform the second learning with respect to the first intermediate neuron based on the number of input subjects thus determined.

15. The neural processor of claim 14, wherein the neural processor is further configured to:
allow the second learning not to be performed with respect to the first intermediate neuron in response to that the number of input subjects thus determined is “1”; and
allow the second learning to be performed with respect to the first intermediate neuron in response to that the number of input subjects thus determined is 2 or more.

16. The neural processor of claim 11, wherein the neural processor is further configured to:
determine input subjects, whose learning is not completed in the first learning, from among the input subjects, based on the intermediate neurons determined to perform the second learning; and
determine the number of intermediate neurons included in the second intermediate neuron layer, based on the number of input subjects whose learning is not completed in the first learning.

17. The neural processor of claim 16, wherein the number of intermediate neurons included in the second intermediate neuron layer is equal to or more than the number of input subjects whose learning is not completed in the first learning.

18. The neural processor of claim 16, wherein the neural processor is further configured to:
initialize synaptic weight values of the intermediate neurons of the first synaptic weight layer, which are determined to perform the second learning with respect to the input subjects whose learning is not completed in the first learning; and
perform the second learning with respect to the partially initialized first synaptic weight layer, the input subjects whose learning is not completed in the first learning, and the intermediate neurons of the second intermediate neuron layer.

19. The neural processor of claim 11, wherein the neural processor is further configured to:
determine intermediate neurons, which will perform third learning, from among intermediate neurons of the second intermediate neuron layer, based on the number of spikes of each of spike output signals of the intermediate neurons of the second intermediate neuron layer;
allow the third learning not to be performed, in response to that each of the intermediate neurons of the second intermediate neuron layer corresponds to only one of the input subjects; and
determine the second synaptic weight layer as a weight layer associated with output neurons.
